(19) United States
(12) Patent Application Publication
(10) Pub. No.: US 2003/0067885 A1
(43) Pub. Date: Apr. 10, 2003

(54) Apparatus and method for predicting physical topologies within optical networks

(76) Inventors: John C. Lynk, Ottawa (CA); Yossi Kanzen, London (GB)

Correspondence Address: NORTEL NETWORKS LIMITED, P. O. BOX 3511, STATION C, OTTAWA, ON, K1Y 4H7, CA

(21) Appl. No.: 09/973,558

(22) Filed: Oct. 9, 2001

(51) Int. Cl. G06F 15/173; H04L 12/28

(52) U.S. Cl. 370/254; 709/223

(57) ABSTRACT

Physical topology for a network can be predicted using information related to the logical connections within the network. The technique includes receiving logical connection information associated with ports within nodes of the network, preparing the logical connection information such that it is easier to determine which ports are logically similar, and predicting physical connections between ports by finding, for each port within the network, at least one other port that is logically similar. In some cases, other techniques for discovering the physical connections within a network are utilized such as auto-discovery.

### BACKGROUND OF THE INVENTION

1. Field of Invention

The present invention relates to networks and, more specifically, to predicting physical topologies within networks.

2. Description of the Related Prior Art

A network commonly includes a plurality of domains or spans, each span comprising a plurality of nodes coupled together with physical connections. A span can be configured in numerous different manners including a ring such as a Bidirectional Line Switched Ring (BLSR) or a mesh. Each span is generally controlled by an Operations Controller (OPC), also known as a Managed Object Agent (MOA), while a Network Manager further controls the overall operation of the network by controlling the various OPCs.

The physical connections between nodes of each span and the physical connections between the spans make up the overall physical topology of the network. It is important for the network administrator, whether consisting of a person or an automated processor within the Network Manager, to have knowledge of the physical topology of the network to accomplish a number of operations including the provisioning of bandwidth and to aid in the correlating of alarms. Further, it is important to have knowledge of the physical topology of the network in order to aid in the planning of expansions to the network.

Unfortunately, after a network of nodes is connected, only logical connection information is visible at the nodes. This logical connection information is often, but not necessarily, represented as Connection Termination Points (CTPs). The physical connections may be unknown to the nodes, OPCs and Network Manager of the network.

A well-known technique in which the physical topology of a network can be generated is with the manual collecting of physical connection information. For instance, at the time of constructing the network, each physical connection that is established between nodes of the network could be recorded into a central physical topology database. With the systematic entry of information with respect to the physical connections, an overall picture of physical topology can be generated.

There are a number of problems with this manual entering of physical topology information. For instance, one problem with this manual technique is the potential of a technician making an error or an omission when entering the physical connection information into the central physical topology database. Further, there is the potential that the physical topology database might mistakenly not be updated to coincide with future changes to the network, such as expansions. Still further, this technique cannot be used if you require the physical topology of a pre-existing network.

After the establishment of the network, to check the recorded physical connections and/or to gain physical connection information in the case that not all physical connections were recorded, a technician would need to manually follow each physical cable to determine which ports within which nodes are physically connected together. This process of manually following physical cables is not practical for large networks due to the excessive amount of labour required and the fact that the results would likely be prone to errors in a similar fashion to the entering of physical connection information at the time of establishing the network.

Therefore, there is a need for a technique to capture and/or check the physical connections within a network in a manner that does not require manual collection of physical connection information.

### SUMMARY OF THE INVENTION

The present invention is directed to an apparatus and method for predicting a physical topology for a network using information related to the logical connections within the network. The technique of one embodiment of the present invention includes receiving logical connection information associated with ports within nodes of the network, preparing the logical connection information such that it is easier to determine which ports are logically similar, and predicting physical connections between ports by finding, for each port within the network, at least one other port that is logically similar. In some embodiments of the present invention, other techniques for discovering the physical connections within a network are utilized such as autodiscovery.

In a first broad aspect, the present invention is a processing apparatus arranged to be coupled to a network of nodes linked together by physical connections. The processing apparatus includes a receiver and a processor coupled to the receiver. The receiver operates to receive at least one logical connection parameter associated with each of at least one port within a plurality of the nodes. The processor operates to process the received logical connection parameters in order to predict at least one physical connection between two of the ports within the plurality of nodes based upon the results of the processing.

According to a second broad aspect, the present invention is a method of predicting at least one physical connection within a network of nodes linked together by physical connections. The method includes receiving at least one logical connection parameter associated with each of at least one port within a plurality of the nodes; processing the received logical connection parameters; and predicting at least one physical connection between two of the ports within the plurality of nodes based upon the results of the processing.

The present invention according to a third broad aspect is a network including a plurality of nodes linked together by physical connections and at least one processing apparatus arranged to be coupled to the nodes. The processing apparatus operates to receive at least one logical connection parameter associated with each of at least one port within a plurality of the nodes; and process the received logical connection parameters in order to predict at least one physical connection between two of the ports within the plurality of nodes based upon the results of the processing.

Other aspects and advantageous features of the present invention will become apparent to those ordinarily skilled in the art upon review of the following description of specific embodiments of the invention in conjunction with the accompanying figures.

### BRIEF DESCRIPTION OF THE FIGURES

Preferred embodiments of the present invention will now be described in detail with reference to the following figures:

FIG. 1 is a block diagram illustrating an optical network in which the present invention could be implemented;

FIG. 2 is a flow chart illustrating the steps to derive a physical topology prediction according to an embodiment of the present invention;

FIG. 3 is a flow chart illustrating the steps to derive a set of probable ports to which a specific port is physically connected according to an embodiment of the present invention;

FIG. 4 is a flow chart illustrating the steps to derive a set of probable ports that a specific port is physically connected according to an alternative embodiment of the present invention;

FIGS. 5A, 5B and 5C are block diagrams illustrating a simple network that utilizes piping (5A) of a logical end to end connection at the well known PDH rate VC 12 (5B) over a higher rate VC 4 connection (5C); and

FIG. 6 is a flow chart illustrating the steps to prepare logical connection data for analysis according to an embodiment of the present invention.

### DETAILED DESCRIPTION OF THE PREFERRED EMBODIMENTS

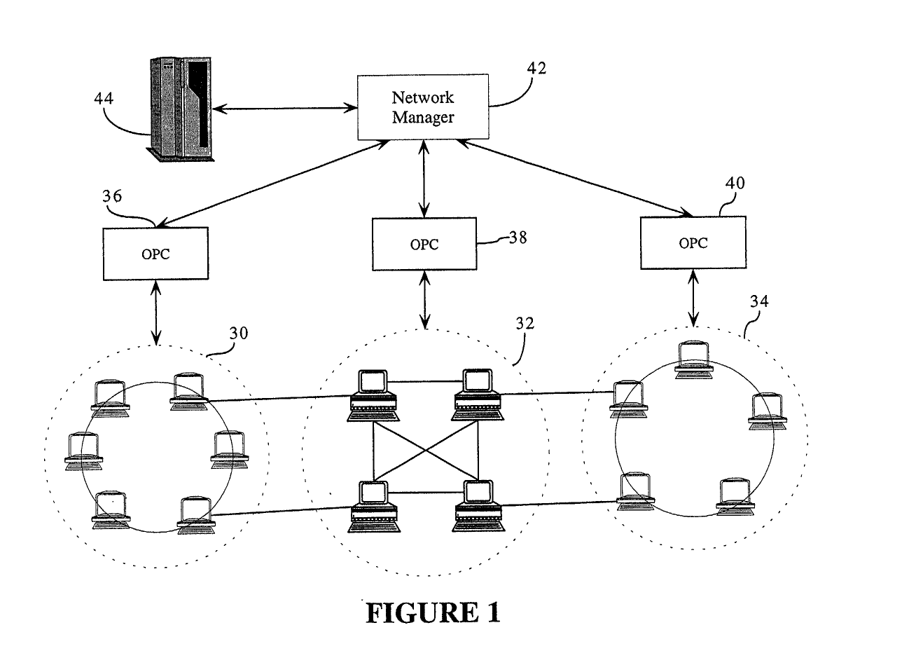

FIG. 1 is a block diagram illustrating a network in which the present invention could be implemented. The network shown is an optical network although the invention is not restricted to an optical network. As depicted, the optical network of FIG. 1 comprises first, second and third spans 30,32,34 that are coupled to first, second and third OPCs 36,38,40. In the case of FIG. 1, the first span 30 is a six node BLSR, the second span 32 is a four node mesh network and the third span 34 is a five node BLSR. The three spans 30,32,34 are coupled together via various physical connections. Further within FIG. 1 is a Network Manager 42 coupled to each of the OPCs 36,38,40 and a connection database 44 coupled to the Network Manager 42. The normal operation of the network of FIG. 1 is well-known in which the OPCs 36,38,40 control the nodes within their respective spans 30,32,34 and the Network Manager 42, controls the operation of the OPCs. As will be appreciated by those in the art, each node includes one or more ports which allow physical nodal connections within and between spans.

It should be recognized that this network is only being illustrated as one sample network in which the present invention could be implemented. The present invention could also be implemented in networks that are more complex with a significant increase in numbers of physical connections and in simpler networks that could include only a single span and no central Network Manager.

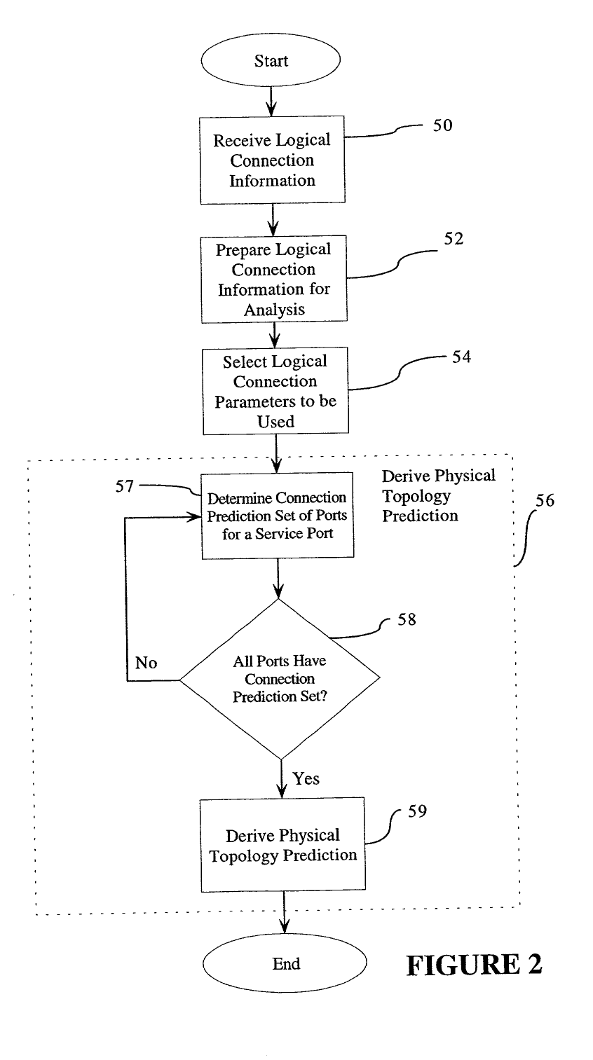

FIG. 2 is a flow chart illustrating the steps to derive a physical topology prediction according to an embodiment of the present invention. For the specific implementation described below, the various processing steps of the present invention are performed in the Network Manager 42. It should be recognized that the present invention could be implemented within another processing component within the network and so the present invention should not be limited simply to implementations within a Network Manager.

As depicted at step 50, initially the Network Manager 42 receives logical connection information. In one embodiment, to accumulate this logical connection information, each of the nodes within the network provide the logical connection information associated with its particular ports to its corresponding OPC and the OPC forwards this information to the connection database 44 via the Network Manager 42. In this case, when the physical topology prediction procedure of FIG. 2 is performed, the Network Manager 42 accesses the logical connection information from the connection database 44. In other embodiments, the Network Manager 42 could request the logical connection information directly from the OPCs or even directly from the nodes. Further, in the case that another processing apparatus is used to perform the procedure of the present invention, it should be understood that various techniques for receiving the logical connection information could be used.

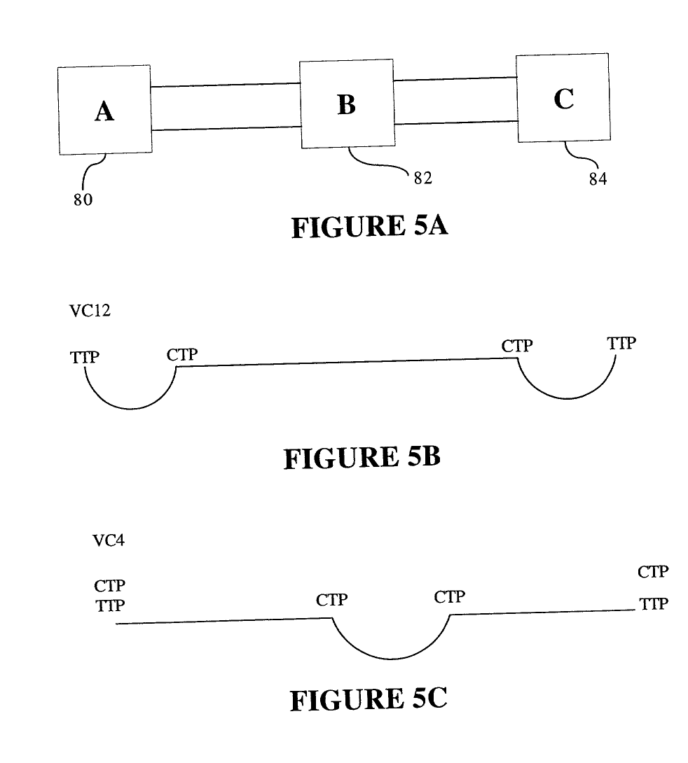

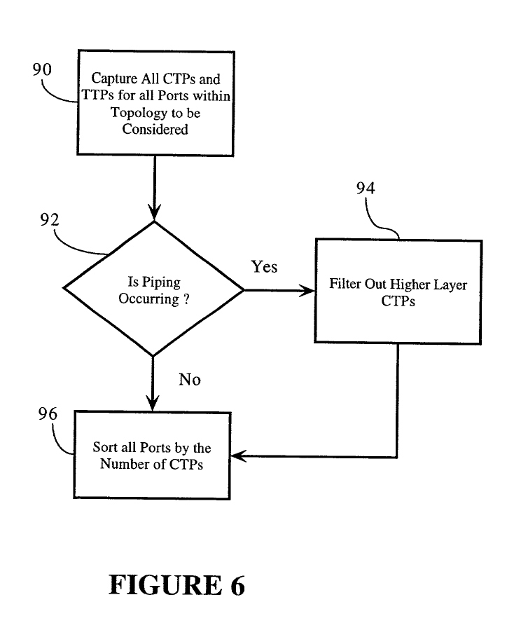

The logical connection information according to one embodiment of the present invention is the Connection Termination Points (CTPs) associated with each port within each node of the network along with logical connection parameters associated with the CTPs. In some embodiments, as will be described herein below with reference to FIGS. 5A-5C and 6, the logical connection information further includes Trail Termination Points (TTPs).

For each CTP, the logical connection parameters include information with respect to which channel within the payload the CTP is associated based upon the well-known JKLM indexing scheme. In some embodiments, the logical connection parameters further include a user label associated with the logical connection of the CTP. In one case, this user label could be associated with a particular customer that is utilizing the logical connection such that all CTPs associated with a particular customer have a common user label. Further, in some embodiments, the span Internet Protocol (IP) address is used in determining the logical similarity between ports. The span IP address is a specific address associated with the OPC for a particular span. The use of such a span IP address is based on the notion that there may be more physical connectivity within a span then between spans. It should be recognized that other logical connection parameters for a CTP could also be used since any parameters of a CTP that are accessible and could distinguish between logical connections could potentially be used as logical connection parameters, as will be described below. Furthermore, it should also be recognized that other parameters associated with the various ports in a network, such as the span IP address, could be used in determining the logical similarity between these ports.

Now turning back to FIG. 2, the next step within the procedure, as depicted at step 52, is to prepare the logical connection information such that the analysis of the information can be performed more efficiently in subsequent steps. It is noted that without this step, the present invention could still function properly, but the subsequent analysis of the logical connection information would likely proceed at a slower rate. To prepare the logical connection information, the CTPs are sorted based upon the port within the network that they are associated. In one embodiment, the CTPs for all the logical connection layers, including all PDH rates and concatenated rates such as STS-12c are included in the sorting and the ports are subsequently arranged in order based upon the total number of CTPs associated with the particular ports, starting with the port(s) having the greatest number and ending with the port(s) having the lowest number. This sorting technique will aid in the determination of which ports have the most number of similar CTPs as will be described below. An alternative embodiment to this technique to sort the ports is also possible that does not utilize all of the CTPs from all of the VC layers as will be described below with reference to FIGS. 5A-5C and 6.

Next, as shown in step 54 of FIG. 2, the Network Manager 42 proceeds to select the logical connection parameter(s) that are to be used in predicting the physical connections within the network. As discussed above, various different logical connection parameters associated with the CTPs could be used within embodiments of the present invention such as the payload channels that the CTPs utilize and the user labels associated with the CTPs. In some embodiments of the present invention, the step of selecting which logical connection parameters to utilize is done with the use of a Graphical User Interface (GUI) integral to Network Manager 42 in which a user may enter his/her preferences. In other embodiments, the selection of the logical connection parameters is done automatically by the Network Manager 42 by analysing what parameters are available. In yet further embodiments, the step of selecting logical connection parameters to utilize is not performed and there are default logical connection parameter(s) selected.

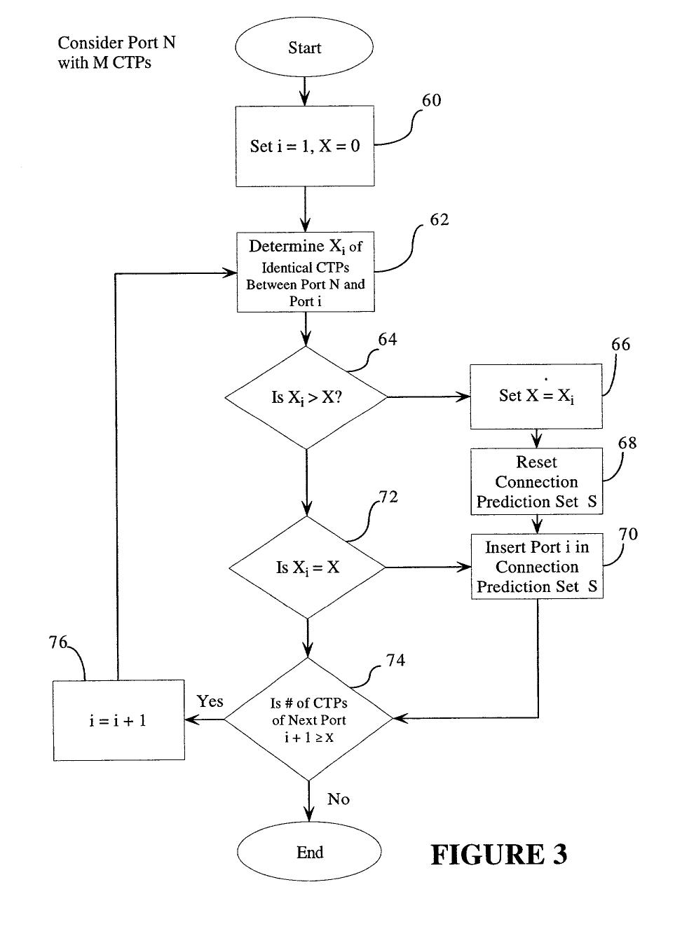

Finally, at step 56, the Network Manager 42 analyses the logical connection information as sorted within step 52 using the logical connection parameters as selected within step 54. To derive a physical topology prediction, the Network Manager 42 determines a connection prediction set of ports for a specific port, as depicted at step 57 and described in detail herein below with reference to FIG. 3, and repeats this step for all other ports as indicated at step 58. Based upon these connection prediction sets, a physical topology prediction for the network can be generated at step 59 as will be described in more detail below. In an alternative embodiment, physical connection predictions are made based upon the connection prediction sets as they are generated and therefore only ports in which a conclusion with respect to their connectivity has not yet been made have connection prediction sets generated at step 57.

FIG. 3 is a flow chart illustrating the steps that the Network Manager 42 performs to derive a set S of most probable ports that a specific port N with M CTPs is physically connected to according to one embodiment of the present invention. The process starts, at step 60, by setting an integer i to one and setting a highest similarity variable x to zero. The highest similarity variable x represents the number of identical CTPs that have been found between the port N and any ports that are within the set S of most probable ports, two CTPs being identical if each of their respective logical connection parameter(s) are identical.

Next, as depicted at step 62, the Network Manager 42 determines a port similarity variable xᵢ that represents the number of CTPs that are identical between the port N and the port i that is being compared. As mentioned above, two CTPs are deemed identical if all of the selected logical connection parameter(s) are identical. In some embodiments, a level of similarity may be all that is needed to conclude that two CTPs are identical. For instance, if the only difference between the logical connection parameter(s) of two CTPs is their respective user labels, some embodiments of the present invention could still deem the two CTPs to be essentially identical.

After determining the port similarity variable xᵢ for the port i, the Network Manager 42 determines, as depicted at step 64, whether the variable xᵢ is greater than the variable x, that is whether the similarity between the port N and the port i is greater than the similarity between the port N and the currently found most probable connected port(s). If the port similarity variable xᵢ is greater than the highest similarity variable x, then the highest similarity variable x is set to the port similarity variable Xᵢ at step 66; the set S containing the most probable port(s) that port N is connected, hereinafter referred to as the connection prediction set S, is reset at step 68; and port i is inserted within the connection prediction set S at step 70.

If the port similarity variable xᵢ is not greater than the highest similarity variable x at step 64, then it is determined whether the two similarity variables are equal at step 72. If it is determined that the port similarity variable xᵢ and the highest similarity variable x are equal, then the port i is inserted in the connection prediction set S at step 70.

After either determining that the port similarity variable xᵢ is less than the highest similarity variable x at step 72 or inserting port i into set S at step 70, the Network Manager 42 proceeds to determine if the number of CTPs of the next port i+1 is greater than or equal to the highest similarity variable x. If it is greater than or equal, then there is the potential that the next port i+1 could be of greater or equal similarity to the ports within the connection prediction set S. Therefore, as shown at step 76, the procedure of FIG. 3 proceeds to set i equal to i+1 and then continue the procedure at step 62, determining a new port similarity variable xᵢ for the new port i.

If, at step 74, it is determined that the number of CTPs for the next port i+1 within the sorted list of ports is less than the highest similarity variable xᵢ, then the procedure of FIG. 3 is completed for the particular port N with the connection prediction set S being saved for port N. With the ports sorted by the number of CTPs from largest to smallest, if the next port i+1 does not have as many CTPs as the port(s) with the greatest similarity to port N have similar CTPs, then neither the next port i+1 nor any further ports that have not been analysed could have an equal or greater port similarity variable as do the port(s) within the connection prediction set S.

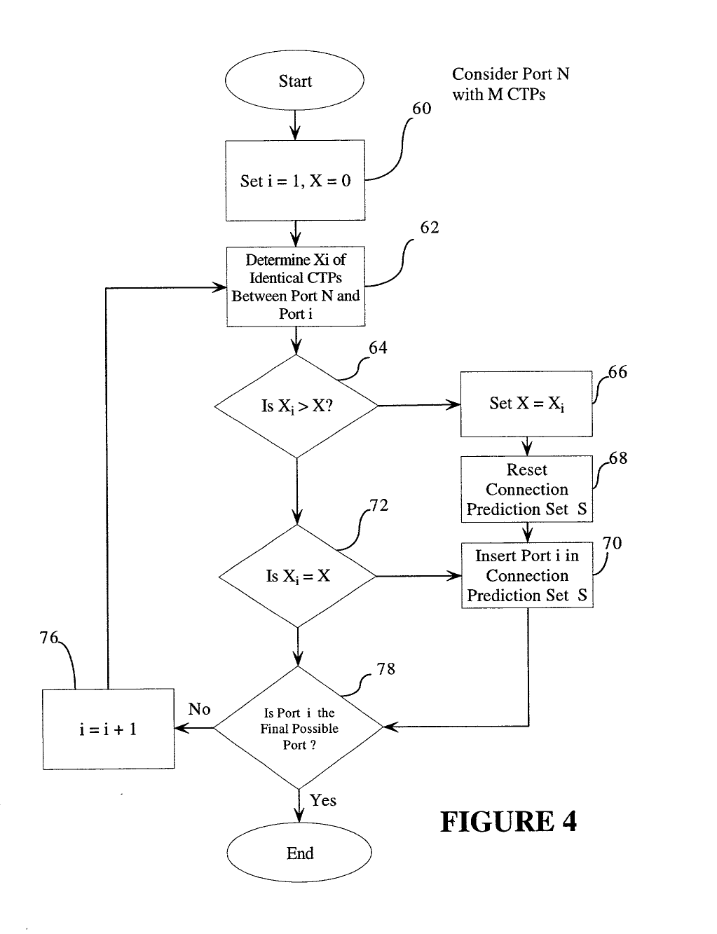

In an alternative embodiment as depicted in FIG. 4, the case that the ports are not sorted based upon the number of CTPs at step 52 is illustrated. In this case, the step 74 is replaced by step 78 in which the Network Manager 42 determines if the port i is the final possible port for connecting to port N. If it is not, then the procedure continues as before at step 76. In this embodiment, only if all possible ports for connecting to port N have been analysed does the procedure terminate. It should be understood that this alternative procedure could result in increased processing time to generate a final connection prediction set S for port N.

As described above with reference to FIG. 2, after the connection prediction sets are generated, a physical topology prediction can be derived at step 59. Alternatively, the connection prediction sets could be presented to a user for analysis at this point.

The derivation of the physical topology prediction could be very simple if each of the connection prediction sets only have two ports within them and there are no connection prediction sets that contain the same port. Unfortunately, in a large complex network, this may not always be the case. In cases that multiple ports are included within a single connection prediction set, the selection of only one of the ports to predict connectivity with could occur in a number of different manners. For instance, a span address for the ports could be used to decide between two ports with identical port similarity variables since it is more likely that a connection is local to a span then to be interspan. Another alternative is for the connection prediction set to be presented to a user so that the user can either guess based upon the limited knowledge they have or can send a technician to manually determine the particular physical connection. Yet another alternative is for the connection prediction set to be put on hold until all of the other connection prediction sets have been analysed so as to determine if one or more of the ports within the connection prediction set are predicted to be connected to another port.

The prediction of physical topologies according to the invention have numerous advantages over the manual determining of physical topologies by either entering the information as the network is being connected or manually following cables to check or determine the physical connections after the network is connected. For one, although the prediction is only a logical guess, the accuracy of this procedure after numerous tests using known network information has proven that in most cases, the rate of error (improperly connected ports) is low. On the other hand, using manual techniques has proven in the past to be a largely inaccurate and incomplete technique. Further, the time to complete the predictions is extremely quick compared to the manual techniques while requiring considerably less labour resources.

One problem with the procedure according to the invention as described above, is the case where piping is performed. This case will now be described with reference to FIGS. 5A through 5C. FIG. 5A is a block diagram illustrating a simple network comprising first, second and third nodes 80,82,84. In this case, the first node 80 is piping data to the third node 84, via the second node 82. FIGS. 5B and 5C illustrate logical depictions of the VC Layer 12 and the VC Layer 4 for this simple network respectively. In this case, as can be seen in FIG. 5B, at VC Layer 12, CTPs are only located at the first and third nodes 80,84, thus leaving no logical evidence that the second node 82 is actually physically coupled between the other two nodes 80,84. As depicted in FIG. 5C, at VC Layer 4, the Trail Termination Point (TTP) and the CTP are at the same ports within the first and third nodes 80,84 and the second node 82 has a CTP at each of the ports that are connected to the first and third nodes 80,84 respectively.

The problem that occurs with piping in the above described procedure of the present invention is due to the fact that within VC Layer 12, it appears, based upon logical connections, that nodes 80 and 84 are connected together directly. Therefore, errors could arise in which the port at the first node 80 is determined to be connected to the port at the third node 84. To overcome this problem, a slightly modified process of preparing the logical connection information for analysis as shown in step 52 of FIG. 2 is utilized as shown in FIG. 6. As depicted at step 90, initially all of the CTPs and TTPs for all ports within the topology to be considered are captured. Next, it is determined whether piping is occurring at step 92. This can be done by determining if there are any situations in which a CTP is at the same port as a TTP. IF it is determined that piping is occurring, then the procedure can filter out all higher layer CTPs as depicted at step 94, thus removing the circumstances illustrated for VC Layer 12 of FIG. 5B. Finally, after either step 92 or 94, the procedure can sort the ports based upon the number of remaining CTPs at step 96 in a similar fashion as described previously with respect to step 52 of FIG. 2.

It is noted that the procedure as described for the present invention could be utilized to generate a physical topology for a network with no additional information or alternatively could be aided by other information to make the analysis simpler. For instance, the procedure of the present invention could be used simply to check physical connections and therefore either the operator or the Network Manager 42 itself could use the previous information to aid in selecting between a plurality of ports within a single connection prediction set.

Further, an incomplete set of physical connections for a network could be used to reduce the number of ports for which connections are not known and therefore reduce the number of connection prediction sets that must be generated.

Still further, an auto-discovery technique could be utilized to provide information with respect to some connections within the network. For instance, one auto-discovery technique that could be utilized with the present invention is disclosed within a U.S. patent application “______” entitled “______” by ______, assigned to the assignee of the present invention and herein incorporated by reference.

Persons skilled in the art will appreciate that there are alternative implementations and modifications of the present invention, and that the above-described implementation is only an illustration of specific embodiments of the invention. Therefore, the scope of the invention should only be limited by the claims appended hereto.

We claim:

1. A processing apparatus arranged to be coupled to a network of nodes linked together by physical connections, the processing apparatus comprising:
a receiver that operates to receive at least one logical connection parameter associated with each of at least one port within a plurality of the nodes; and
a processor, coupled to the receiver, that operates to process the received logical connection parameters in order to predict at least one physical connection between two of the ports within the plurality of nodes based upon the results of the processing.

2. A processing apparatus according to claim 1, wherein to process the received logical connection parameters, the processor operates to, for a first one of the two ports, determine at least one most probable port that the first port is physically connected to, this most probable port being the second of the two ports.

3. A processing apparatus according to claim 1, wherein to process the received logical connection parameters, the processor operates to, for a first one of the two ports, determine a set of most probable ports that the first port is physically connected to, this set of most probable ports including the second of the two ports.

4. A processing apparatus according to claim 3, wherein to determine a set of most probable ports that the first port is physically connected to, the processor operates to determine a port similarity variable for a plurality of the ports when compared to the first port; and insert all ports that were determined to have the largest port similarity variable within the set of most probable ports.

5. A processing apparatus according to claim 4, wherein the port similarity variable for each of the ports when compared to the first port is equal to the number of logical connections that are identical between the first port and the particular port that the port similarity variable is being determined for.

6. A processing apparatus according to claim 1, wherein to process the received logical connection parameters, the processor operates to sort the ports within the plurality of nodes based upon the number of logical connections at the ports; and, for a first one of the two ports, determine a set of most probable ports that the first port is physically connected to, this set of most probable ports including the second of the two ports.

7. A processing apparatus according to claim 6, wherein to determine a set of most probable ports that the first port is physically connected to, the processor operates to determine a port similarity variable for a plurality of the ports when compared to the first port, starting with the port with the largest number of logical connections and proceeding until a subsequent port would have a number of logical connections less than the largest port similarity variable already determined; and insert all ports that were determined to have the largest port similarity variable within the set of most probable ports.

8. A processing apparatus according to claim 1 wherein if there are a plurality of logical connection parameters associated with each of the at least one ports, the processor selects one or more of the plurality of logical connection parameters to predict the at least one physical connection.

9. A processing apparatus according to claim 8 wherein the selecting is performed with a graphical user interface integral to said processor.

10. A processing apparatus according to claim 1, wherein to predict at least one physical connection between two of the ports within the plurality of nodes, the processor operates to predict physical connections between a plurality of pairs of the plurality of nodes based upon the results of the processing.

11. A processing apparatus according to claim 1, wherein the at least one logical connection parameter associated with each of at least one port within a plurality of the nodes comprises logical channel information.

12. A processing apparatus according to claim 1, wherein the at least one logical connection parameter associated with each of at least one port within a plurality of the nodes comprises a user label.

13. A processing apparatus according to claim 3, wherein, if multiple ports are included within the set of most probable ports, a span address associated with each port is used to determine the port with which there is a physical connection.

14. A processing apparatus according to claim 1, wherein the processor predicts at least one physical connection between two of the ports within the plurality of nodes based upon the results of the processing and based upon known physical connection information with respect to the network.

15. A processing apparatus according to claim 16, wherein the known physical connection information comprises information generated within an auto discovery procedure.

16. A processing apparatus according to claim 1, wherein to receive at least one logical connection parameter associated with each of at least one port within a plurality of the nodes, the receiver operates to receive stored information from a database.

17. A network manager for a network of nodes comprising a processing apparatus according to claim 1.

18. A method of predicting at least one physical connection within a network of nodes linked together by physical connections, the method comprising:
receiving at least one logical connection parameter associated with each of at least one port within a plurality of the nodes;
processing the received logical connection parameters; and
predicting at least one physical connection between two of the ports within the plurality of nodes based upon the results of the processing.

19. A method according to claim 18, wherein the processing step comprises, for a first one of the two ports, determining at least one most probable port that the first port is physically connected to, this most probable port being the second of the two ports.

20. A method according to claim 18, wherein the processing step comprises, for a first one of the two ports, determining a set of most probable ports that the first port is physically connected to, this set of most probable ports including the second of the two ports.

21. A method according to claim 20, wherein the determining a set of most probable ports that the first port is physically connected to comprises:
determining a port similarity variable for a plurality of the ports when compared to the first port; and
inserting all ports that were determined to have the largest port similarity variable within the set of most probable ports.

22. A method according to claim 18, wherein the processing step comprises:
sorting the ports within the plurality of nodes based upon the number of logical connections at the ports;
for a first one of the two ports, determining a port similarity variable for a plurality of the ports when compared to the first port, starting with the port with the largest number of logical connections and proceeding until a subsequent port would have a number of logical connections less than the largest port similarity variable already determined; and
inserting all ports that were determined to have the largest port similarity variable within a set of most probable ports that the first port is physically connected to, this set of most probable ports including the second of the two ports.

24. A method according to claim 18, wherein the at least one logical connection parameter associated with each of at least one port within a plurality of the nodes comprises at least one of logical channel information and a user label.

25. A method according to claim 18, wherein the predicting at least one physical connection between two of the ports within the plurality of nodes is performed based upon the results of the processing along with known physical connection information with respect to the network.

26. A network comprising:
a plurality of nodes linked together by physical connections;
at least one processing apparatus arranged to be coupled to the nodes, the processing apparatus operating to receive at least one logical connection parameter associated with each of at least one port within a plurality of the nodes; and process the received logical connection parameters in order to predict at least one physical connection between two of the ports within the plurality of nodes based upon the results of the processing.

27. A network according to claim 30 further comprising a database for storing the logical connection parameters;
wherein to receive at least one logical connection parameter associated with each of at least one port within a plurality of the nodes, the processing apparatus operates to receive stored information from the database.

28. A network according to claim 26 wherein the network is an optical network.
